(19) United States
(12) Patent Application Publication
(10) Pub. No.: US 2026/0018346 A1
(43) Pub. Date: Jan. 15, 2026

(54) MULTILAYER CERAMIC CAPACITOR

(71) Applicant: Murata Manufacturing Co., Ltd., Nagaokakyo-shi (JP)

(72) Inventor: Eiji TERAOKA, Nagaokakyo-shi (JP)

(21) Appl. No.: 19/338,085

(22) Filed: Sep. 24, 2025

Related U.S. Application Data
(63) Continuation of application No. PCT/JP2024/014100, filed on Apr. 5, 2024.

(30) Foreign Application Priority Data
Jun. 22, 2023 (JP) 2023-102335

(51) Int. Cl. H01G 4/30; H01G 4/012; H01G 4/232

(52) U.S. Cl. CPC H01G 4/30; H01G 4/012; H01G 4/232

(57) ABSTRACT

A multilayer ceramic capacitor includes a multilayer body including dielectric layers and internal electrode layers, which are alternately stacked, and two main surfaces on opposite sides from each other in a stacking direction, two end surfaces on opposite sides from each other in a length direction orthogonal to the stacking direction, and two side surfaces on opposite sides from each other in a width direction orthogonal to both the stacking and length directions, and first and second external electrodes. A distance between the side surfaces is shorter than a distance between the end surfaces. The first and second external electrodes are located on the first end surface and the second end surface, or the first side surface and the second side surface, respectively. At least one or all of the internal electrode layers are not connected to either of the first external electrode or the second external electrode.

### CROSS REFERENCE TO RELATED APPLICATIONS

This application claims the benefit of priority to Japanese Patent Application No. 2023-102335, filed on Jun. 22, 2023, and is a Continuation application of PCT Application No. PCT/JP2024/014100, filed on Apr. 5, 2024. The entire contents of each application are hereby incorporated herein by reference.

### BACKGROUND OF THE INVENTION

### 1. Field of the Invention

The present invention relates to multilayer ceramic capacitors.

### 2. Description of the Related Art

Conventionally, multilayer ceramic capacitors intended to have a low capacitance have been proposed. Japanese Unexamined Patent Application, Publication No. H8-45776 describes a multilayer ceramic capacitor in which one internal electrode is provided inside a dielectric and is not connected to external electrodes.

### SUMMARY OF THE INVENTION

However, such a multilayer ceramic capacitor including one internal electrode is greatly affected by a manufacturing error, and cannot easily be set to a desired capacitance in some cases.

Example embodiments of the present invention provide low-capacitance multilayer ceramic capacitors that each can be easily set to a desired capacitance.

An example embodiment of the present invention provides a multilayer ceramic capacitor including a multilayer body including a dielectric layer and an internal electrode layer that are alternately laminated, a first main surface and a second main surface opposed to each other in a lamination direction, a first end surface and a second end surface opposed to each other in a length direction orthogonal to the lamination direction, and a first side surface and a second side surface opposed to each other in a width direction orthogonal to both the lamination direction and the length direction, and a first external electrode and a second external electrode. In the multilayer ceramic capacitor, a distance between the first side surface and the second side surface is shorter than a distance between the first end surface and the second end surface, the first external electrode and the second external electrode are respectively provided on the first end surface and the second end surface or the first side surface and the second side surface, the internal electrode layer includes a plurality of internal electrode layers, and at least one or all of the plurality of internal electrode layers are not connected to either the first external electrode or the second external electrode.

Example embodiments of the present invention provide low-capacitance multilayer ceramic capacitors that each can be easily set to a desired capacitance.

The above and other elements, features, steps, characteristics and advantages of an example embodiment of the present invention will become more apparent from the following detailed description of the example embodiments with reference to the attached drawings.

### BRIEF DESCRIPTION OF THE DRAWINGS

FIG. 1 is a perspective view illustrating a multilayer ceramic capacitor 1 according to an example embodiment of an example embodiment of the present invention.

FIG. 2 is a cross-sectional view of the multilayer ceramic capacitor of FIG. 1, taken along line I-I.

FIG. 3 is a cross-sectional view of the multilayer ceramic capacitor of FIG. 1, taken along line II-II.

FIG. 4 is a perspective view illustrating a multilayer ceramic capacitor according to a first modification of an example embodiment of the present invention.

FIG. 5 is a cross-sectional view of the multilayer ceramic capacitor of FIG. 4, taken along line V-V.

FIG. 6 is a cross-sectional view of the multilayer ceramic capacitor of FIG. 4, taken along line VI-VI.

FIG. 7 is a diagram corresponding to FIG. 2, and illustrates a multilayer ceramic capacitor according to a second modification of an example embodiment of the present invention.

FIG. 8 is a diagram corresponding to FIG. 3, and illustrates a multilayer ceramic capacitor according to a variation of the second modification of an example embodiment of the present invention.

FIG. 9 is a diagram corresponding to FIG. 2, and illustrates a multilayer ceramic capacitor according to a third modification of an example embodiment of the present invention.

FIG. 10 is a diagram corresponding to FIG. 2, and illustrates a multilayer ceramic capacitor according to a variation of the third modification of an example embodiment of the present invention.

FIG. 11 is a diagram corresponding to FIG. 2, and illustrates a multilayer ceramic capacitor according to a fourth modification of an example embodiment of the present invention.

### DETAILED DESCRIPTION OF THE EXAMPLE EMBODIMENTS

Example embodiments of the present invention will be described below with reference to the accompanying drawings. In the drawings, the same or equivalent portions are denoted by the same reference signs.

### Structure of Multilayer Ceramic Capacitor 1

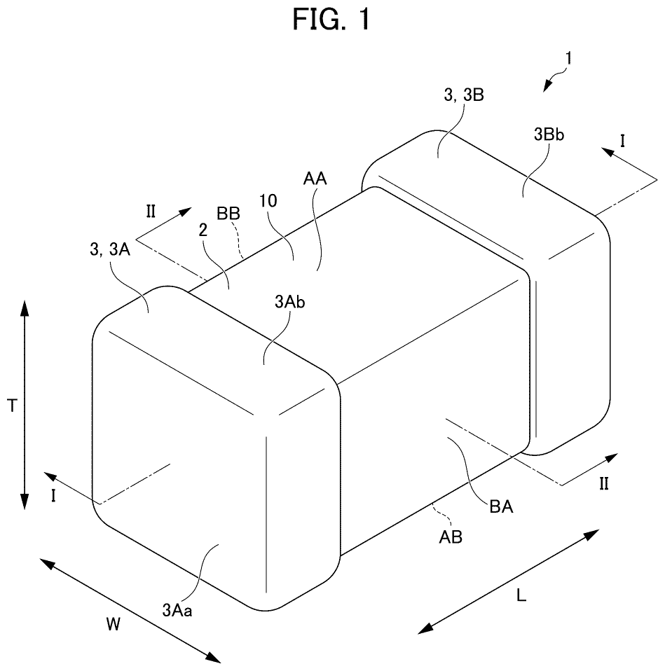

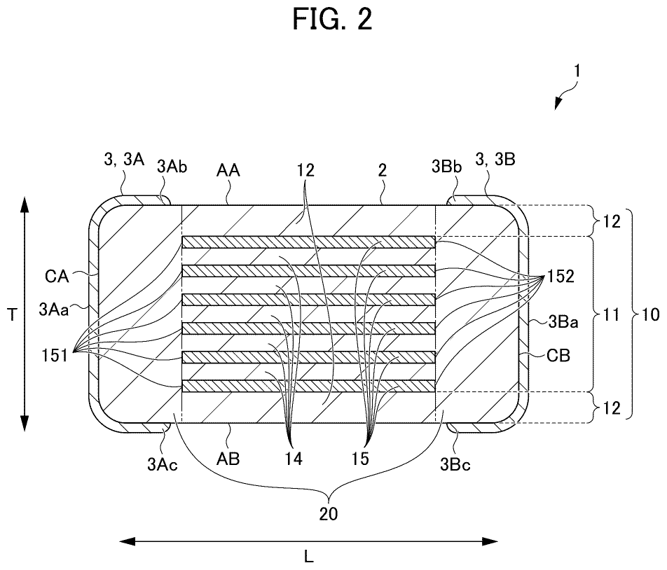

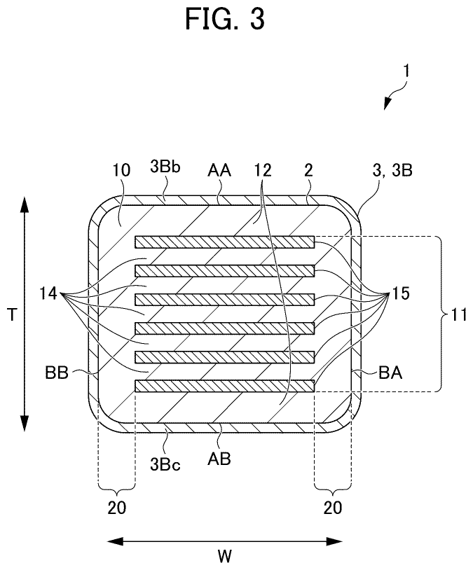

The following describes a structure of a multilayer ceramic capacitor 1 according to an example embodiment of an example embodiment of the present invention with reference to FIGS. 1 to 3. FIG. 1 is a perspective view illustrating the multilayer ceramic capacitor 1 according to the present example embodiment. FIG. 2 is a cross-sectional view of the multilayer ceramic capacitor of FIG. 1, taken along line I-I. FIG. 3 is a cross-sectional view of the multilayer ceramic capacitor of FIG. 1, taken along line II-II.

The multilayer ceramic capacitor 1 has a substantially rectangular parallelepiped shape and includes a multilayer body 2, a first external electrode 3A, and a second external electrode 3B. The multilayer body 2 includes an inner layer portion 11 (described later in detail) including a plurality of sets of dielectric layers 14 and internal electrode layers 15 that are alternately laminated. The first external electrode 3A and the second external electrode 3B may be collectively referred to as “external electrode(s) 3”.

The following terms are used to indicate directions in the multilayer ceramic capacitor 1 in the description below. A direction in which the dielectric layers 14 and the internal electrode layers 15 are laminated in the multilayer ceramic capacitor 1 (inner layer portion 11) is defined as a lamination direction T. A direction orthogonal to the lamination direction T is defined as a length direction L. A direction orthogonal to both the length direction L and the lamination direction T is defined as a width direction W. Accordingly, the cross section illustrated in FIG. 2 is also referred to as an LT cross section, and the cross section illustrated in FIG. 3 is also referred to as an WT cross section.

As will be described in detail later, the first external electrode 3A and the second external electrode 3B are opposed to each other in the length direction L. In this case, the length direction L is an electrode opposed direction in which the first external electrode 3A and the second external electrode 3B are opposed to each other. An LT cross section of the multilayer body 2 is a cross section along the lamination direction T and the electrode opposed direction.

### Multilayer Body 2

The multilayer body 2 has a substantially rectangular parallelepiped shape. In the following description, among the six outer surfaces of the multilayer body 2, a pair of outer surfaces opposed to each other in the lamination direction T is referred to as two main surfaces A, a pair of outer surfaces opposed to each other in the width direction W is referred to as two side surfaces B, and a pair of outer surfaces opposed to each other in the length direction L is referred to as two end surfaces C. One of the two main surfaces A is referred to as a first main surface AA, and the other is referred to as a second main surface AB. One of the two end surfaces C is referred to as a first end surface CA, and the other is referred to as a second end surface CB. The first main surface AA and the second main surface AB are collectively referred to as a main surface(s) A when it is unnecessary to particularly distinguish from each other. The first end surface CA and the second end surface CB are collectively referred to as an end surface(s) C when it is unnecessary to particularly distinguish from each other.

The distance between the first side surface BA and the second side surface BB is shorter than the distance between the first end surface CA and the second end surface CB.

### Multilayer Main Body 10

The multilayer body 2 includes a multilayer main body 10 and a pair of side margin portions 20.

The multilayer main body 10 includes the inner layer portion 11 and a pair of outer layer portions 12.

### Inner Layer Portion 11

The inner layer portion 11 includes the plurality of sets of the dielectric layers 14 and the internal electrode layers 15 alternately laminated in the lamination direction T.

### Dielectric Layer 14

Each dielectric layer 14 includes, as a main component, a ceramic material including at least one of Ca, Zr, or Ti. Specifically, for example, the main component is a ceramic material having a perovskite structure including Ca and Zr and represented by a general formula ABO₃. Examples of the ceramic material having such a perovskite structure include, but are not limited to, CaZro₃ (calcium zirconate) or TiO₂ (titanium oxide). The ceramic material of each dielectric layer 14 may include all of Ca, Zr, and Ti as a main component. Furthermore, Ca(Zr_{0.9}Ti_{0.1})O₃, which results from substituting a portion of ZrO₃ or a portion of Zr of CaZro₃ with Ti, or a similar material may be used.

Each dielectric layer 14 preferably includes Ca, Sr, Ti, and Zr. When the amount of Zr is defined as 100 moles, each dielectric layer 14 preferably includes Ca and Sr such that the total of Ca and Sr is 60 moles or more and 110 moles less and includes Ti in an amount of 20 moles or less, for example.

The ceramic material of each dielectric layer 14 may be, for example, (Ca_{1-x-y}, Srₓ, Ba_{y})m(Zr_{1-z-α}, Ti_{z}, Hf_{α})O₃ (where x is about 0 or more and about 1 or less, y is about 0 or more and about 0.4 or less, m is about 0.9 or more and about 1.1 or less, z is about 0 or more and about 0.2 or less, and x is about 0 or more and about 0.3 or less) or the like.

An additive may be added to the ceramic material of each dielectric layer 14 in accordance with applications. Examples of the additive include, but are not limited to: Mn, Mg, Dy, or Cr; oxides of rare earth elements such as V, Sm, Eu, Gd, Tb, Ho, Er, Tm, Yb, or Y; oxides of Co, Ni, Li, B, Na, K, or Si; and glass.

The material of each dielectric layer 14 may be, for example, a ceramic material including a component such as BaTiO₃, CaTiO₃, SrTiO₃, or CaZrO₃ or the like. The ceramic material may additionally include a Mn compound, a Fe compound, a Cr compound, a Co compound, or a Ni compound, or the like as a subcomponent.

Each dielectric layer 14 may have any thickness, but the thickness is preferably about 50 μm or less, for example. The total number of the dielectric layers 14 including the outer layer portions 12 (described later in detail) is preferably two or more and fifteen or less, for example.

### Internal Electrode Layer 15

In the LT cross section illustrated in FIG. 2, each of the internal electrode layers 15 includes a first external electrode side end 151 that is an end adjacent to the first external electrode 3A and a second external electrode side end 152 that is an end adjacent to the second external electrode 3B. The position in the width direction W at which the LT cross section of FIG. 2 is taken is merely an example, and an LT cross section may be taken at an arbitrary position in the width direction W. In LT cross sections each including the internal electrode layers 15, each internal electrode layer 15 includes the first external electrode side end and the second external electrode side end irrespective of the positions in the width direction W at which the LT cross sections are taken.

The internal electrode layers 15 face each other in the lamination direction T with the dielectric layers 14 interposed therebetween. The first external electrode side ends 151 and the second external electrode side ends 152 are exposed at the respective end portions of the inner layer portion 11 in the length direction L. The ends of each internal electrode layer 15 in the width direction W are not exposed from the ends of the inner layer portion 11 in the width direction W (see FIG. 3). All the internal electrode layers 15 have the same or substantially the same electrode area.

Each internal electrode layer 15 is a conductive thin film made of a metal material such as, for example, Ni, Cu, Ag, or Pd, or an alloy of Ag and Pd, or Au. In order for the multilayer ceramic capacitor 1 to have suitable frequency characteristics, it is preferable to use Cu as the internal electrode layers 15. Each internal electrode layer 15 may further include dielectric particles of the same composition system as the ceramic included in the dielectric layers 14.

Each internal electrode layer 15 may include, for example, metal Ni as a main component. Alternatively, each internal electrode layer 15 may include, as a main component, at least one selected from a metal such as Cu, Ag, Pd, or Au, or an alloy including at least one of these metals, such as an Ag—Pd alloy. Alternatively, each internal electrode layer 15 may include any of the foregoing materials as a component other than the main component.

Each internal electrode layer 15 may include dielectric particles of the same composition system as the ceramic included in the dielectric layers 14, as a component other than the main component. In the present specification, a metal as the main component refers to a metal component included in the highest mass %.

Each internal electrode layer 15 preferably has a thickness of about 1.0 μm or greater and about 3.0 μm or less, for example. The total number of the internal electrode layers 15 is preferably two or more and ten or less, for example.

### Outer Layer Portion 12

The outer layer portions 12 sandwich the inner layer portion 11 in the lamination direction T. Each outer layer portion 12 is made of a dielectric ceramic material similar to that of the dielectric layers 14. Each outer layer portion 12 preferably has a thickness of about 20 μm or greater and about 150 μm or less, for example.

### Side Margin Portion 20

The side margin portions 20 sandwich the multilayer main body 10 in the length direction L. The side margin portions 20 respectively cover the ends of the internal electrode layers 15 in the width direction W. Each side margin portion 20 is made of a dielectric ceramic material similar to that of the dielectric layers 14. Each side margin portion 20 preferably has a thickness of about 10 μm or greater and about 100 μm or less, for example.

### External Electrode 3

The first external electrode 3A is provided on the first end surface CA. The first external electrode 3A extends from the first end surface CA to a portion of the first main surface AA, a portion of the second main surface AB, a portion of the first side surface BA, and a portion of the second side surface BB. In the first external electrode 3A, the portion provided on the first end surface CA is referred to as a first end surface-electrode portion 3Aa, the portion provided on the first main surface AA is referred to as a first main surface-electrode portion 3Ab, and the portion provided on the second main surface AB is referred to as a second main surface-electrode portion 3Ac.

The second external electrode 3B is provided on the second end surface CB. The second external electrode 3B extends from the second end surface CB to a portion of the first main surface AA, a portion of the second main surface AB, a portion of the first side surface BA, and a portion of the second side surface BB. In the second external electrode 3B, the portion provided on the second end surface CB is referred to as a second end surface-electrode portion 3Ba, the portion provided on the first main surface AA is referred to as a first main surface-electrode portion 3Bb, and the portion provided on the second main surface AB is referred to as a second main surface-electrode portion 3Bc.

In the following description, the first end surface-electrode portion 3Aa and the second end surface-electrode portion 3Ba may be collectively referred to as “end surface-electrode portion(s) 3a”. The first main surface-electrode portion 3Ab of the first external electrode 3A and the first main surface-electrode portion 3Bb of the second external electrode 3B may be collectively referred to as “first main surface-electrode portion(s) 3b”. The second main surface-electrode portion 3Ac of the first external electrode 3A and the second main surface-electrode portion 3Bc of the second external electrode 3B may be collectively referred to as “second main surface-electrode portion(s) 3c”.

Although not illustrated, each external electrode 3 includes, for example, a base electrode layer, an inner plating layer, and a surface plating layer. The base electrode layer is formed by, for example, applying and baking a conductive paste including a conductive metal and glass. Examples of the conductive metal included in the base electrode layer include Cu, Ni, Ag, Pd, an Ag—Pd alloy, Au, and the like. The inner plating layer is, for example, a Ni plating layer. The surface plating layer is, for example, a Sn plating layer. The inner plating layer and the surface plating layer can be formed by, for example, an electrolytic plating method or an electroless plating method.

The multilayer ceramic capacitor 1 including the multilayer body 2 and the external electrodes 3 preferably has a dimension of about 0.02 mm or greater and about 0.65 mm or less in the length direction L, and a dimension of about 0.10 mm or greater and about 0.35 mm or less in each of the lamination direction T and the width direction W, for example.

Here, each internal electrode layer 15 is not connected to either the first external electrode 3A or the second external electrode 3B (see FIG. 2). This configuration allows the multilayer ceramic capacitor 1 to have a low capacitance.

Preferably, among the first external electrode side ends 151, the first external electrode side end 151 closest to the first external electrode 3A and the first external electrode side end 151 farthest from the first external electrode 3A are separated from each other by a distance of about 5 μm or less in the electrode opposed direction (length direction L), for example. Preferably, among the second external electrode side ends 152, the second external electrode side end 152 closest to the second external electrode 3B and the second external electrode side end 152 farthest from the second external electrode 3B are separated from each other by a distance of about 5 μm or less in the length direction L. In this case, all the internal electrode layers 15 are separated from the first external electrode 3A by a same or substantially the same distance. All the internal electrode layers 15 are separated from the second external electrode 3B by a same or substantially the same distance. Due to this configuration, the multilayer ceramic capacitor 1 can be easily set to a desired capacitance.

The distance between each internal electrode layer 15 and the first external electrode 3A in the length direction L is preferably about 10 μm or greater and about 200 μm or less, and more preferably about 50 μm or greater and about 200 μm or less, for example. The distance between each internal electrode layer 15 and the second external electrode 3B in the length direction L is preferably about 10 μm or greater and about 200 μm or less, and more preferably about 50 μm or greater and about 200 μm or less, for example.

The distance between each internal electrode layer 15 and the first external electrode 3A in the width direction W is preferably about 10 μm or greater and about 100 μm or less, and more preferably about 50 μm or greater and about 100 μm or less on each of the side adjacent to the first side surface BA and the side adjacent to the second side surface BB, for example. The distance between each internal electrode layer 15 and the second external electrode 3B in the width direction W is preferably about 10 μm or greater and about 100 μm or less, and more preferably about 50 μm or greater and about 100 μm or less on each of the side adjacent to the first side surface BA and the side adjacent to the second side surface BB side, for example.

The internal electrode layers 15 do not face the first main surface-electrode portions 3b in the lamination direction T. The internal electrode layers 15 do not face the second main surface-electrode portions 3c in the lamination direction T.

### Method of Manufacturing Multilayer Ceramic Capacitor

Next, a non-limiting example of a method of manufacturing the multilayer ceramic capacitor 1 will be described.

First, a ceramic slurry is formed into a sheet shape, thereby preparing ceramic green sheets for lamination. The ceramic green sheets for lamination include a ceramic raw material including a dielectric ceramic material, a binder, and a solvent. An additive including a rare earth element may be added to the ceramic raw material.

A conductor paste to form internal electrode layers is printed on the ceramic green sheets for lamination. The conductor paste is printed in a plurality of stripes arranged side-by-side in the width direction of the stripes on a surface of each of the ceramic green sheets for lamination. As a method of printing the conductor paste, a screen printing method or a gravure printing method can be used, for example.

A predetermined number of ceramic green sheets without printed conductor paste are laminated. Next, a predetermined number of the ceramic green sheets having the conductor paste printed thereon are laminated. Next, a predetermined number of ceramic green sheets without printed conductor paste are laminated. In this way, a mother multilayer body is obtained.

The mother multilayer body is pressed. As a method of pressing the mother multilayer body, a method such as rigid press or isostatic press can be used, for example.

The pressed mother multilayer body is cut into a chip shape. As a method of cutting the mother multilayer body, press cutting, dicing, or laser cutting can be used, for example. The mother multilayer body is cut in the lamination direction T along the length direction of the stripes of the conductive paste. Specifically, the mother multilayer body is cut at positions where the conductive paste is not printed. In this way, the conductive paste can be prevented from being exposed on the cut surfaces of the mother multilayer body, which have resulted from the cutting.

The mother multilayer body is cut in the lamination direction T along a direction orthogonal to the length direction of the stripes of the conductive paste. The conductive paste is exposed on the cut surfaces of the mother multilayer body, which have resulted from the cutting. Specifically, the cut surfaces and the ends of the conductive paste on the cut surfaces are substantially flush with each other. As a result, the positions of the ends of the internal electrode layers 15 in the length direction L can be easily arranged at substantially the same position in the length direction L. In the above-described manner, the multilayer main body 10 is obtained.

Ceramic green sheets for side margin are attached to the multilayer main body 10. The ceramic green sheets for side margin are attached to the cut surfaces where the conductive paste is exposed. Thus, the side margin portions 20 are formed on the multilayer main body 10. As a result, the multilayer body 2 is obtained.

Preferably, the multilayer body 2 is subjected to barrel polishing or the like. As a result, corners and ridges of the multilayer body 2 are rounded.

The multilayer body 2 is degreased in a nitrogen atmosphere. Subsequently, the multilayer body 2 is fired in a mixed atmosphere of nitrogen, hydrogen, and water vapor. The temperature at which the multilayer body 2 is fired is preferably about 900° C. or higher and about 1300° C. or lower, for example.

Next, the external electrodes 3 are formed on the multilayer body 2. For example, a base electrode layer, an inner plating layer, and a surface plating layer are sequentially formed on each of the end surfaces C of the multilayer body 2. The layers are formed, for example, by the above-described method.

In the above-described manner, the multilayer ceramic capacitor 1 can be obtained.

### Effects

The above-described example embodiment achieves the following advantageous effects.

According to the above-described example embodiment, all the internal electrode layers 15 are not connected to either the first external electrode 3A or the second external electrode 3B. This feature allows the multilayer ceramic capacitor 1 to have a low capacitance.

According to the above-described example embodiment, the multilayer ceramic capacitor 1 includes the plurality of internal electrode layers 15. Due to this feature, the area of a portion where each external electrode 3 faces the internal electrode layers 15 is determined depending on the number of the internal electrode layers 15. Thus, the capacitance of the multilayer ceramic capacitor 1 can be easily adjusted by adjusting the number of the internal electrode layers 15.

As a result, it is possible to provide a low-capacitance multilayer ceramic capacitor that can be easily set to a desired capacitance.

Furthermore, since the multilayer ceramic capacitor 1 includes the plurality of internal electrode layers 15, the equivalent series resistance (ESR) can be reduced.

According to the above-described example embodiment, among the first external electrode side ends 151, the first external electrode side end 151 closest to the first external electrode 3A and the first external electrode side end 151 farthest from the first external electrode 3A are separated from each other by a distance of, for example, preferably about 5 μm or less in the electrode opposed direction (length direction L). Among the second external electrode side ends 152, the second external electrode side end 152 closest to the second external electrode 3B and the second external electrode side end 152 farthest from the second external electrode 3B are separated from each other by a distance of, for example, preferably about 5 μm or less in the length direction L. In this case, all the internal electrode layers 15 are separated from the first external electrode 3A by substantially the same distance. All the internal electrode layers 15 are separated from the second external electrode 3B by substantially the same distance. Due to this configuration, the multilayer ceramic capacitor 1 can be easily set to a desired capacitance.

According to the above-described example embodiment, each dielectric layer 14 includes Ca, Sr, Ti, or Zr. This feature makes it possible to provide a multilayer ceramic capacitor the capacitance of which changes at a low rate with respect to temperature.

According to the above-described example embodiment, each internal electrode layer 15 includes Cu as a main component. This feature makes it possible to provide a multilayer ceramic capacitor the capacitance of which changes at a low rate with respect to temperature.

### Modifications

Next, multilayer ceramic capacitors according to modifications of example embodiments of the present invention will be described. Differences from the multilayer ceramic capacitor 1 according to the above example embodiments will be mainly described. The same components as those of the multilayer ceramic capacitor 1 according to the above example embodiments will be denoted by the same reference signs, and description thereof may be omitted.

### First Modification

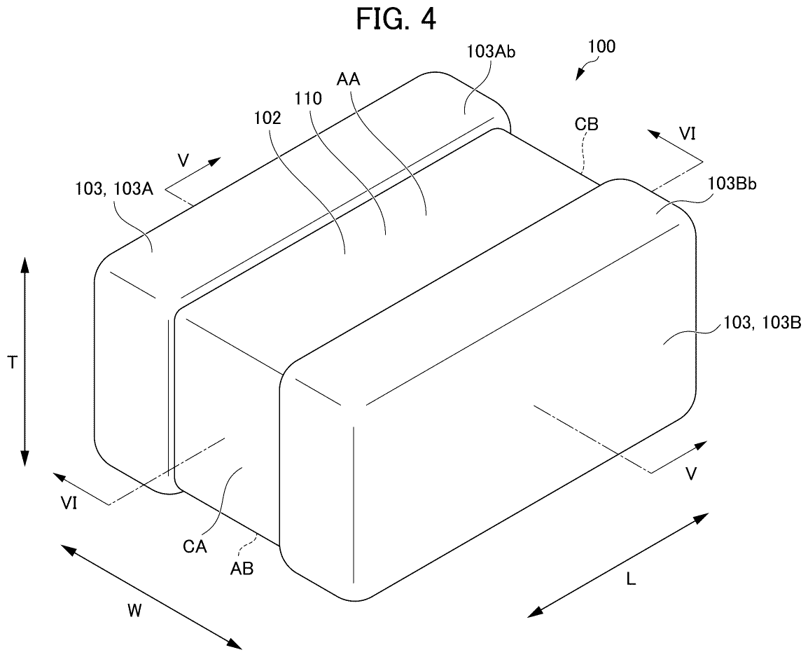

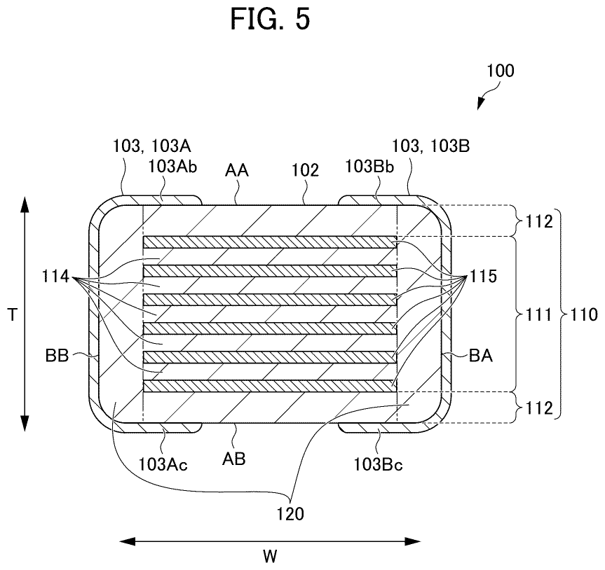

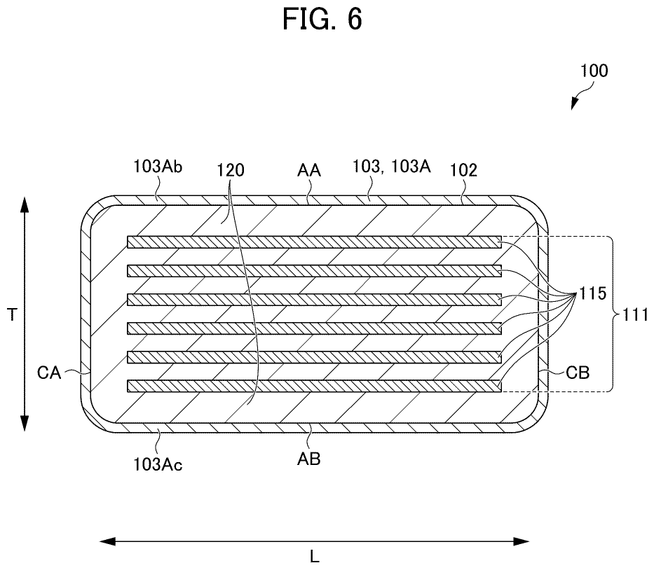

A multilayer ceramic capacitor 100 according to a first modification of an example embodiment of the present invention will be described with reference to FIGS. 4 to 6. FIG. 4 is a perspective view illustrating the multilayer ceramic capacitor 100 according to the first modification of an example embodiment of the present invention. FIG. 5 is a cross-sectional view of the multilayer ceramic capacitor of FIG. 4, taken along line V-V. FIG. 6 is a cross-sectional view of the multilayer ceramic capacitor of FIG. 4, taken along line VI-VI.

The multilayer ceramic capacitor 100 includes a multilayer body 102, a first external electrode 103A, and a second external electrode 103B.

The multilayer body 102 includes an inner layer portion 111 including outer surfaces which are opposed to each other in a width direction W and on which internal electrode layers 115 are exposed. Specifically, each of the outer surfaces and the ends of the internal electrode layers 115 in the width direction W are flush or substantially flush with each other. The internal electrode layers 115 are not exposed on outer surfaces of the inner layer portion 11 that are opposed to each other in a length direction L.

In the multilayer body 102, side margin portions 120 sandwich a multilayer main body 110 in the width direction W. Similarly to the multilayer body 2 of the above-described example embodiments, the multilayer body 102 has a larger dimension in the length direction L than in the width direction W.

The first external electrode 103A is provided on a first side surface BA. The first external electrode 103A extends to a portion of a first main surface AA, a portion of a second main surface AB, a portion of a first end surface CA, and a portion of a second end surface CB. In the first external electrode 103A, the portion provided on the first main surface AA is referred to as a first main surface-electrode portion 103Ab, and the portion provided on the second main surface AB is referred to as a second main surface-electrode portion 103Ac.

The second external electrode 103B is provided on a second side surface BB. The second external electrode 103B extends to a portion of the first main surface AA, a portion of the second main surface AB, a portion of the first end surface CA, and a portion of the second end surface CB. In the second external electrode 103B, the portion provided on the first main surface is referred to as a first main surface-electrode portion 103Bb, and the portion provided on the second main surface AB is referred to as a second main surface-electrode portion 103Bc. The first main surface-electrode portion 103Ab of the first external electrode 103A and the first main surface-electrode portion 103Bb of the second external electrode 103B may be collectively referred to as “first main surface electrode portion(s) 103b”. The second main surface-electrode portion 103Ac of the first external electrode 103A and the second main surface-electrode portion 103Bc of the second external electrode 103B may be collectively referred to as “second main surface electrode portion(s) 103c”.

The width direction W is an electrode opposed direction in which the first external electrode 103A and the second external electrode 103B are opposed to each other. A WT cross section of the multilayer body 102 corresponds to a cross section taken along the lamination direction T and the electrode opposed direction.

The first external electrode 103A and the second external electrode 103B sandwich the multilayer body 102 in the width direction W. In this case, the spacing between the first external electrode 103A and the second external electrode 103B is narrower than that of the multilayer ceramic capacitor 1 of the above-described example embodiments, thus shortening the current path. As a result, the equivalent series inductance (ESL) can be reduced.

The internal electrode layers 115 face each of the first main surface-electrode portions 103b in the lamination direction T. The internal electrode layers 115 face each of the second main surface-electrode portions 103c in the lamination direction T. In this case, the capacitance of the multilayer ceramic capacitor 100 can be adjusted by adjusting the area in which the internal electrode layers 115 face each of the external electrodes 103 in the lamination direction T. As a result, the degree of freedom in setting the capacitance of the multilayer ceramic capacitor 100 can be increased.

### Second Modification

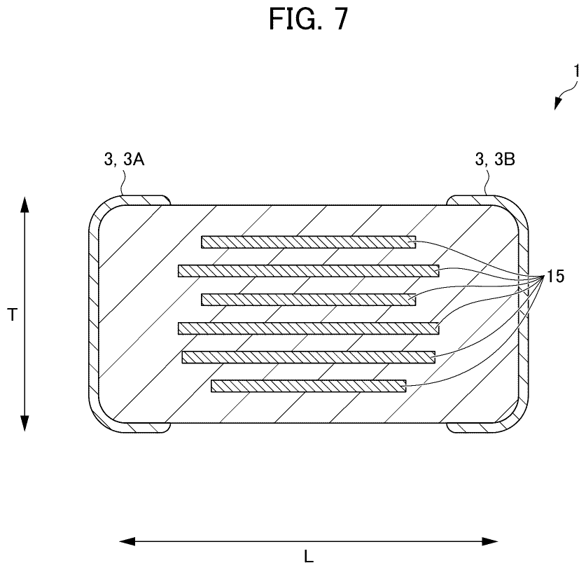

A multilayer ceramic capacitor 1 according to a second modification of an example embodiment of the present invention will be described with reference to FIG. 7. FIG. 7 is a diagram corresponding to FIG. 2, and illustrates the multilayer ceramic capacitor 1 according to the second modification of an example embodiment of the present invention.

The multilayer ceramic capacitor 1 according to the second modification of an example embodiment of the present invention includes a plurality of internal electrode layers 15, at least one of which has a different dimension in the length direction L from the remainder. All the internal electrode layers 15 have the same dimension in the width direction W, for example. In this case, the at least one of the plurality of internal electrode layers 15 has an electrode area different from that of the remainder of the plurality of internal electrode layers 15. Due to this configuration, since the capacitance of the multilayer ceramic capacitor 1 can be adjusted by adjusting the electrode areas of the internal electrode layers 15, the degree of freedom in setting the capacitance of the multilayer ceramic capacitor 1 can be increased.

### Variation of Second Modification

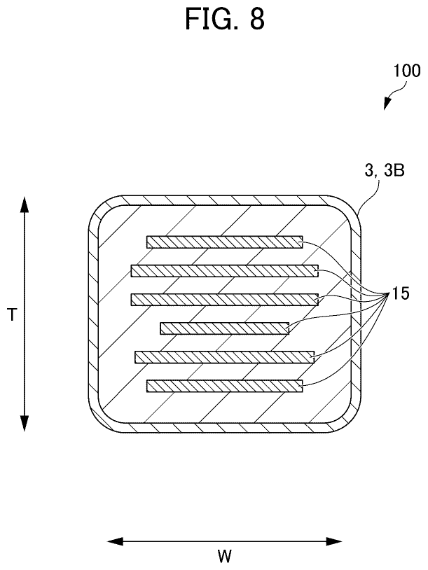

A multilayer ceramic capacitor 1 according to a variation of the second modification of an example embodiment of the present invention will be described with reference to FIG. 8. FIG. 8 is a diagram corresponding to FIG. 3, and illustrates the multilayer ceramic capacitor 1 according to the variation of the second modification of an example embodiment of the present invention.

The multilayer ceramic capacitor 1 according to the variation of the second modification of an example embodiment of the present invention includes a plurality of internal electrode layers 15, at least one of which has a different dimension in the width direction W from the remainder. All the internal electrode layers 15 have the same dimension in the length direction L, likewise to the above-described example embodiment. In this case, a configuration can be achieved in which the at least one of the plurality of internal electrode layers 15 has an electrode area different from that of the remainder, while all the internal electrode layers 15 are separated from each external electrode 3 by the same distance. This configuration makes it possible to increase the degree of freedom in setting the capacitance of the multilayer ceramic capacitor 1, while making it easy to set the multilayer ceramic capacitor 1 to a desired capacitance.

### Third Modification

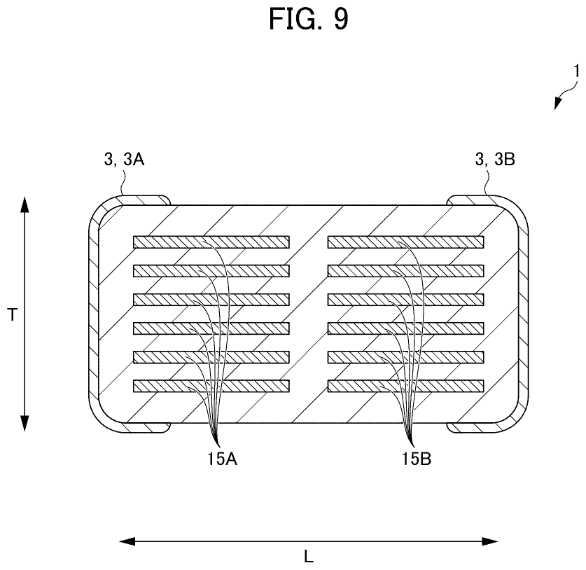

A multilayer ceramic capacitor 1 according to a third modification of an example embodiment of the present invention will be described with reference to FIG. 9. FIG. 9 is a diagram corresponding to FIG. 2, and illustrates the multilayer ceramic capacitor 1 according to the third modification of an example embodiment of the present invention.

The multilayer ceramic capacitor 1 according to the third modification of an example embodiment of the present invention includes a plurality of internal electrode layers 15 including a plurality of first internal electrode layers 15A laminated so as to face each other in the lamination direction T, and a plurality of second internal electrode layers 15B laminated so as to face each other in the lamination direction T at a position where the plurality of second internal electrode layers 15B do not face the plurality of first internal electrode layers 15A in the lamination direction T. The set of the laminated first internal electrode layers 15A and the set of the laminated second internal electrode layers 15B are arranged side-by-side in the length direction L (electrode arrangement direction). Arranging the internal electrode layers 15 in a plurality of lines allows the multilayer ceramic capacitor 1 to have a low capacitance. The first internal electrode layers 15A are arranged at substantially the same positions in the lamination direction T as the second internal electrode layers 15B.

To manufacture the multilayer ceramic capacitor 1 according to the third modification of an example embodiment of the present invention, ceramic green sheets without printed conductive paste and ceramic green sheets on each of which a conductive paste to form the first internal electrode layers 15A and a conductive paste to form the second internal electrode layers 15B are printed are alternately laminated. This process provides for the arrangement in which the first internal electrode layers 15A are provided at substantially the same positions in the lamination direction T as the second internal electrode layers 15B.

### Variation of Third Example Embodiment

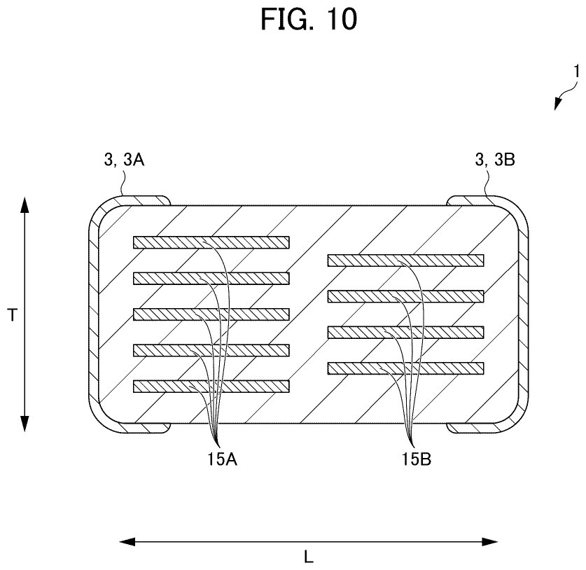

A multilayer ceramic capacitor 1 according to a variation of the third modification of an example embodiment of the present invention will be described with reference to FIG. 10. FIG. 10 is a diagram corresponding to FIG. 2, and illustrates the multilayer ceramic capacitor 1 according to the variation of the third modification of an example embodiment of the present invention.

In the multilayer ceramic capacitor 1 according to the variation of the third modification of an example embodiment of the present invention, the first internal electrode layers 15A and the second internal electrode layers 15B are arranged so as to be shifted in the lamination direction T. This configuration allows the multilayer ceramic capacitor 1 to have a lower capacitance.

To manufacture the multilayer ceramic capacitor 1 according to the variation of the third modification of an example embodiment of the present invention, ceramic green sheets having a conductive paste printed on a portion adjacent to one end in the length direction L and ceramic green sheets having a conductive paste printed on a portion adjacent to the other end in the length direction L are alternately laminated. This process provides for the arrangement in which the first internal electrode layers 15A and the second internal electrode layers 15B are shifted in position from each other in the lamination direction T.

### Fourth Modification

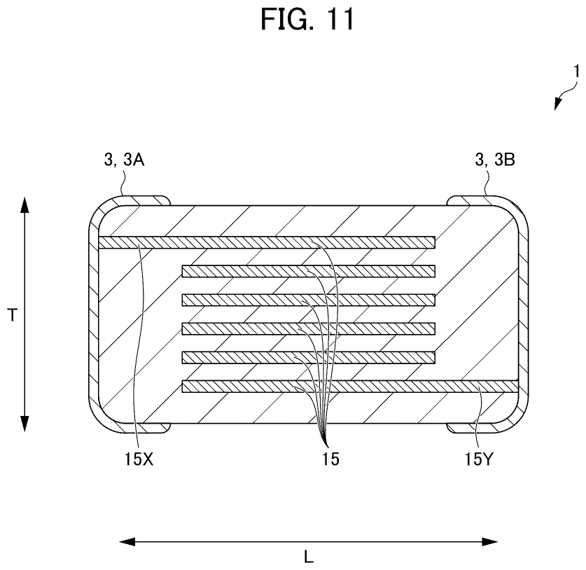

A multilayer ceramic capacitor 1 according to a fourth modification of an example embodiment of the present invention will be described with reference to FIG. 11. FIG. 11 is a diagram corresponding to FIG. 2, and illustrates the multilayer ceramic capacitor 1 according to the fourth modification of an example embodiment of the present invention.

The multilayer ceramic capacitor 1 according to the fourth modification of an example embodiment of the present invention includes a plurality of internal electrode layers 15, at least one of which is connected to at least one of a first external electrode 3A or a second external electrode 3B. More specifically, the internal electrode layer 15 (hereinafter, referred to as “internal electrode layer 15X”) closest to the first end surface CA among the plurality of internal electrode layers 15 is connected to the first external electrode 3A. The internal electrode layer 15 (hereinafter, referred to as “internal electrode layer 15Y”) closest to the second end surface CB among the plurality of internal electrode layers 15 is connected to the second external electrode 3B. In this manner, at least one of the internal electrode layers 15 may be connected to the external electrode 3. The capacitance of the multilayer ceramic capacitor 1 according to the fourth modification is greater than that of the above-described example embodiment and that of each modification. Therefore, the capacitance of the multilayer ceramic capacitor 1 can be adjusted in a relatively large range depending on whether or not at least one of the internal electrode layers 15 is connected to at least one of the external electrodes 3.

It should be noted that any one of the plurality of internal electrode layers 15 may be connected to at least one of the first external electrode 3A or the second external electrode 3B without any particular limitation. The internal electrode layer 15 to be connected can be arbitrarily chosen as long as the plurality of internal electrode layers 15 include one or more internal electrode layers 15 that are not connected to either the first external electrode 3A or the second external electrode 3B. The plurality of internal electrode layers 15 may include at least one internal electrode layers 15 connected to both the first external electrode 3A and the second external electrode 3B.

### Modification of Method of Manufacturing Multilayer Ceramic Capacitor

In the above-described example embodiment, the internal electrode layers 15 are formed by preparing ceramic green sheets having a conductive paste printed in stripes and by cutting the ceramic green sheets at an intermediate position between the stripes. However, the method of forming the internal electrode layers is not limited thereto. The internal electrode layers may be formed by, for example, printing a conductive paste on ceramic green sheets in a desired shape of the internal electrode layer. In this case, it is possible to prevent the conductive paste from being exposed on the outer surfaces of a multilayer body chip, thereby enabling omission of a later step of attaching the side margin portions to the multilayer body chip. However, the manufacturing method described in the above example embodiment is preferred because it makes it easy to arrange the ends of the internal electrode layers in the electrode opposed direction at substantially the same position in the electrode opposed direction.

In the method of manufacturing the multilayer ceramic capacitor according to the above example embodiment, the electrode opposed direction may be set to one of the length direction L and the width direction W, which is not the direction in which the side margin portions 20 are opposed to each other. In this case, in the step of cutting the mother multilayer body along the conductive paste printed in stripes, the mother multilayer body is cut at a position separated from the conductive paste, so that the multilayer ceramic capacitor in which the internal electrode layers are not connected to either the first external electrode or the second external electrode can be manufactured. However, the configurations and the manufacturing methods of the above example embodiments are preferred because they make it easy to arrange the ends of the internal electrode layers in the electrode opposed direction at substantially the same position in the electrode opposed direction.

Furthermore, the conductive paste may be printed on the entire upper surface of each of the ceramic green sheets, and a mother multilayer body including the ceramic green sheets may be cut into a predetermined size, so that multilayer body chips are produced. In this case, since the conductive paste is exposed on the surfaces in the length direction L and the surfaces in the width direction W of each multilayer body chip, the side margin portion is attached to each of the surfaces in the length direction L and the surfaces in the width direction W of each multilayer body chip in a later step. In the multilayer body produced by this manufacturing method, the ends of the internal electrode layers in the length direction L are at substantially the same position in the length direction L, and the ends of the internal electrode layers in the width direction W are at substantially the same position in the width direction W. For this reason, the multilayer body can be suitably used in both a configuration in which the first external electrode and the second external electrode are opposed to each other in the length direction L and a configuration in which the first external electrode and the second external electrode are opposed to each other in the width direction W.

It should be noted that the present invention is not limited to the above-described example embodiments and modifications, and encompasses the scope described below.

While example embodiments of the present invention have been described above, it is to be understood that variations and modifications will be apparent to those skilled in the art without departing from the scope and spirit of an example embodiment of the present invention. The scope of an example embodiment of the present invention, therefore, is to be determined solely by the following claims.

What is claimed is:

1. A multilayer ceramic capacitor comprising:
a multilayer body including a dielectric layer and an internal electrode layer that are alternately laminated, a first main surface and a second main surface opposed to each other in a lamination direction, a first end surface and a second end surface opposed to each other in a length direction orthogonal to the lamination direction, and a first side surface and a second side surface opposed to each other in a width direction orthogonal to both the lamination direction and the length direction; and
a first external electrode and a second external electrode; wherein
a distance between the first side surface and the second side surface is shorter than a distance between the first end surface and the second end surface;
the first external electrode and the second external electrode are respectively provided on the first end surface and the second end surface or the first side surface and the second side surface;
the internal electrode layer includes a plurality of internal electrode layers; and
at least one or all of the plurality of internal electrode layers are not connected to either the first external electrode or the second external electrode.

2. The multilayer ceramic capacitor according to claim 1, wherein
in a cross section of the multilayer body along the lamination direction and an electrode opposed direction in which the first external electrode and the second external electrode are opposed to each other, each of the plurality of internal electrodes includes a first external electrode side end adjacent to the first external electrode and a second external electrode side end adjacent to the second external electrode;
among a plurality of the first external electrode side ends, the first external electrode side end closest to the first external electrode and the first external electrode side end farthest from the first external electrode are separated from each other by a distance of about 5 μm or less in the electrode opposed direction; and
among a plurality of the second external electrode side ends, the second external electrode side end closest to the second external electrode and the second external electrode side end farthest from the second external electrode are separated from each other by a distance of about 5 μm or less in the electrode opposed direction.

3. The multilayer ceramic capacitor according to claim 1, wherein at least one of the plurality of internal electrode layers has an electrode area different from that of a remainder of the plurality of internal electrode layers.

4. The multilayer ceramic capacitor according to claim 1, wherein the plurality of internal electrode layers include a plurality of first internal electrode layers facing each other in the lamination direction, and a plurality of second internal electrode layers facing each other in the lamination direction at a position where the plurality of second internal electrode layers do not face the plurality of first internal electrode layers in the lamination direction.

5. The multilayer ceramic capacitor according to claim 1, wherein
each of the first external electrode and the second external electrode includes a first main surface-electrode portion on the first main surface and a second main surface-electrode portion on the second main surface; and
the plurality of internal electrode layers face the first main surface-electrode portion and the second main surface-electrode portion of the first external electrode and the second external electrode in the lamination direction.

6. The multilayer ceramic capacitor according to claim 1, wherein at least one of the plurality of internal electrode layers is connected to at least one of the first external electrode or the second external electrode.

7. The multilayer ceramic capacitor according to claim 1, wherein the dielectric layer includes Cr, Sr, Ti, or Zr.

8. The multilayer ceramic capacitor according to claim 1, wherein each of the plurality of internal electrode layer includes Cu as a main component.

9. The multilayer ceramic capacitor according to claim 1, wherein the dielectric layer includes Ca, Zr or Ti.

10. The multilayer ceramic capacitor according to claim 1, wherein the dielectric layer includes all of Ca, Zr and Ti.

11. The multilayer ceramic capacitor according to claim 1, wherein the dielectric layer includes all of Cr, Sr, Ti, and Zr.

12. The multilayer ceramic capacitor according to claim 1, wherein the dielectric layer includes BaTiO₃, CaTiO₃, SrTiO₃, or CaZrO₃.

13. The multilayer ceramic capacitor according to claim 1, wherein each of the plurality of internal electrodes includes Ni, Cu, Ag, or Pd, an alloy of Ag and Pd, or Au.

14. The multilayer ceramic capacitor according to claim 1, wherein each of the plurality of internal electrodes has a thickness of about 1.0 μm or greater and about 3.0 μm or less.

15. The multilayer ceramic capacitor according to claim 1, wherein a total number of the plurality of internal electrodes is two or more and ten or less.

16. The multilayer ceramic capacitor according to claim 1, wherein the multilayer ceramic capacitor has a dimension of about 0.02 mm or greater and about 0.65 mm or less in the length direction, and a dimension of about 0.10 mm or greater and about 0.35 mm or less in each of the lamination direction and the width direction.

17. The multilayer ceramic capacitor according to claim 1, wherein all of the plurality of internal electrode layers are separated from the first external electrode by a same or substantially the same distance.

18. The multilayer ceramic capacitor according to claim 1, wherein all of the plurality of internal electrode layers are separated m the second external electrode by a same or substantially the same distance.

19. The multilayer ceramic capacitor according to claim 1, wherein
a distance between each of the plurality of internal electrode layers and the first external electrode in the length direction is about 10 μm or greater and about 200 μm or less;
a distance between each of the plurality of internal electrode layers and the second external electrode in the length direction is about 10 μm or greater and about 200 μm or less;
a distance between each of the plurality of internal electrode layers and the first external electrode in the width direction is about 10 μm or greater and about 100 μm or less; and
a distance between each of the plurality of internal electrode layers and the second external electrode in the width direction is about 10 μm or greater and about 100 μm or less.

20. The multilayer ceramic capacitor according to claim 1, wherein
a distance between each of the plurality of internal electrode layers and the first external electrode in the length direction is about 50 μm or greater and about 200 μm or less;
a distance between each of the plurality of internal electrode layers and the second external electrode in the length direction is about 50 μm or greater and about 200 μm or less;
a distance between each of the plurality of internal electrode layers and the first external electrode in the width direction is about 50 μm or greater and about 100 μm or less; and
a distance between each of the plurality of internal electrode layers and the second external electrode in the width direction is about 50 μm or greater and about 100 μm or less.
